(19) United States
(12) Patent Application Publication
(10) Pub. No.: US 2005/0188390 A1
(43) Pub. Date: Aug. 25, 2005

(54) OPTICAL DISC DRIVE CAPABLE OF ADJUSTING DISC-IN AND DISC-OUT SPEEDS

(76) Inventors: Tsung-Jung Kuo, Taipei City (TW); Jui-Chiang Lin, Taipei City (TW)

Correspondence Address: NORTH AMERICA INTERNATIONAL PATENT OFFICE (NAIPC), P.O. BOX 506, MERRIFIELD, VA, 22116, US

(21) Appl. No.: 10/710,338

(22) Filed: Jul. 1, 2004

(30) Foreign Application Priority Data
Feb. 25, 2004 (TW) 093104834

(51) Int. Cl. G11B 7/00; G11B 7/135; G11B 17/03; G11B 17/04; G11B 33/02

(52) U.S. Cl. 720/621; 720/602

(57) ABSTRACT

An optical disc drive capable of adjusting disc-in and disc-out speeds is provided. The optical disc drive includes a housing, an adjusting unit for adjusting a current or a voltage, a motor for adjusting rotation speed based on the adjusted current and voltage, and a roller driven by the motor for adjusting disc-in and disc-out speeds.

### BACKGROUND OF INVENTION

1. Field of the Invention

The present invention relates to an optical disc drive, and more particularly, to an optical disc drive which can adjust disc-in and disc-out speeds.

2. Description of the Prior Art

Optical discs, such as compact discs (CDs) and digital versatile discs (DVDs), have become one of the most important storage media in modern society because of their compact size, low cost, and high storage capacity. Optical discs are played by optical disc drives. Besides storing normal documents or programs, optical discs are widely used for storing multimedia data such as audio streams and video streams. An optical disc drive has to be used for accessing the data stored in the optical discs.

When pushing the disc into the optical disc drive, the users finger may be clipped due to a fast disc-in speed of optical disc drive, and is thus injured. But the disc-in and disc-out speeds of the conventional optical disc drive are fixed, for a clumsy user, it is risky to utilize an optical disc drive with a fast disc-in speed, but an impatient user always desires a faster disc-in speed to shorten waiting time.

### SUMMARY OF INVENTION

It is therefore a primary objective of the claimed invention to provide an optical disc drive capable of adjusting the disc-in and disc-out speeds to solve the above-mentioned problem.

According to the claimed invention, an optical disc drive comprises a housing, an adjusting unit for adjusting a current or a voltage, a motor for adjusting rotation speed based on the adjusted current or voltage, and a roller driven by the motor for adjusting disc-in and disc-out speeds of a disc.

According to the claimed invention, an optical disc drive capable of adjusting tray-in and tray-out speeds comprises a housing, a tray for supporting a disc, an adjusting unit for adjusting a current or a voltage, a motor for adjusting rotation speed based on the adjusted current or voltage, and a tray-driving device driven by the motor for adjusting tray-in and tray-out speeds based on the rotation speed of the motor.

The adjusting unit can be a variable current source or a variable voltage source or software code stored in a memory.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 shows a disc ejecting out of an optical disc drive according to the present invention.

FIG. 2 is a schematic diagram of the optical disc drive shown in FIG. 1.

FIG. 3 is a block diagram of the optical disc drive shown in FIG. 1.

FIG. 4 shows a relationship of a driving current of a DC motor versus a torque and a rotate speed.

FIG. 5 shows a relationship of a driving current versus torque.

FIG. 6 shows a disc on a tray ejecting out of an optical disc drive according another embodiment of the present invention.

FIG. 7 is a block diagram of the optical disc drive shown in FIG. 6.

### DETAILED DESCRIPTION

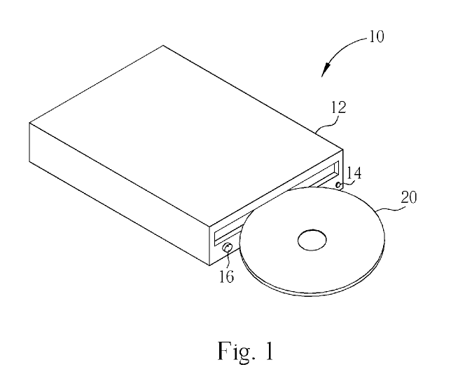

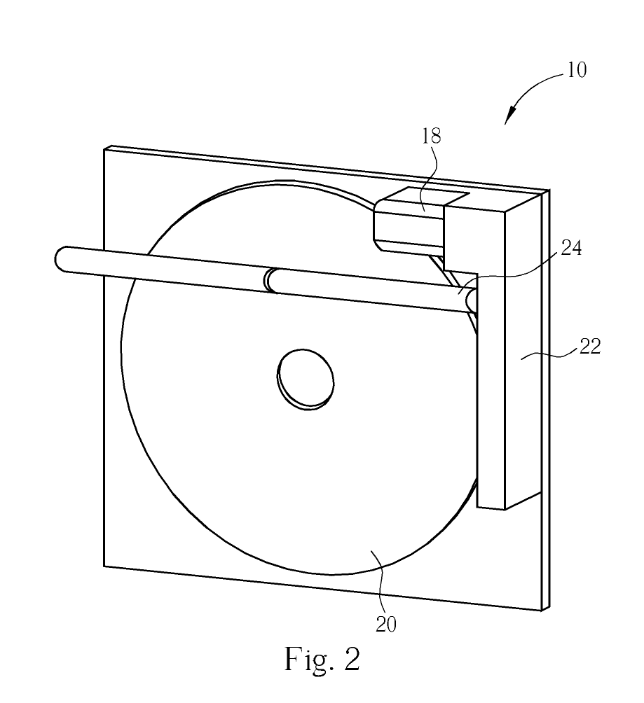

Please refer to FIG. 1 and FIG. 2. FIG. 1 shows a disc 20 ejecting out of an optical disc drive 10 according to the present invention. FIG. 2 is a schematic diagram of the optical disc drive 10 shown in FIG. 1. The optical disc drive 10 comprises a housing 12, a disc-driving button 14, a speed-adjusting device 16, a motor 18, a gear box 22, and a roller 24. The user can press the disc-driving button 14 or utilize a software interface by means of a computer to control the motor 18 to drive the motor 18 as well as to control the roller 24 to feed or eject the disc 20. The speed-adjusting device 16, which can be a turntable or a knob, is used for adjusting disc-in and disc-out speeds.

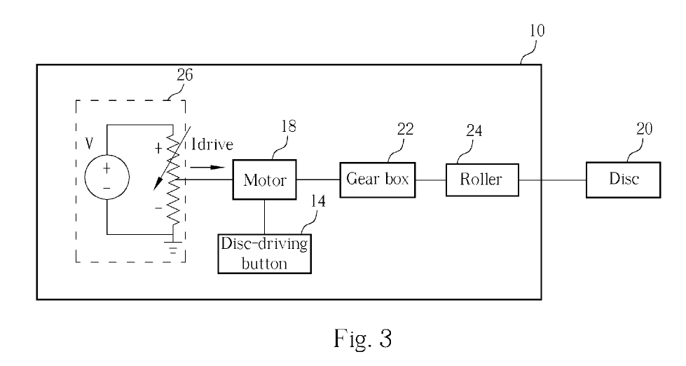

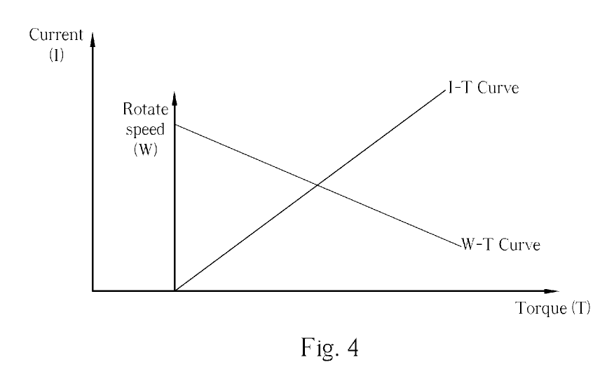

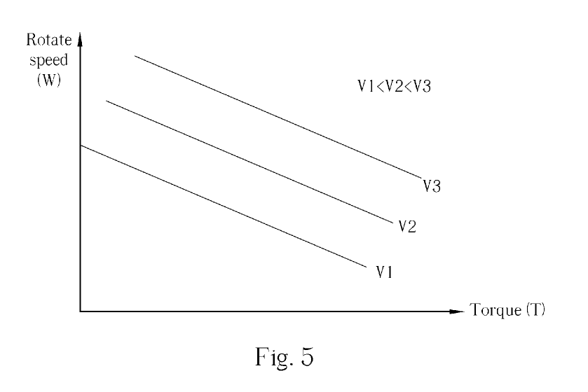

Please refer to FIGS. 2, 3, 4, and 5. FIG. 3 is a block diagram of the optical disc drive 10 shown in FIG. 1. FIG. 4 shows a relationship of a driving current of a DC motor versus a torque and a rotate speed. FIG. 5 shows a relationship of a driving current versus torque. The optical disc drive 10 further comprises an adjusting unit 26 connected to the motor 18. In this embodiment, the adjusting unit 26 can be a combination of a variable resistor and a constant voltage source, or a combination of a variable resistor and a constant current source. The resistance of the variable resistor of the adjusting unit 26 can be changed by means of the speed-adjusting device 16. The rotate speed of the motor 18 is changed through a change of the output current or the output voltage of the adjusting unit 26. As shown in FIG. 3, suppose that a voltage V across the adjusting unit 26 is a constant. If the resistance of the variable resistor is changed, the driving current I_{drive} is changed, and the rotate speed of the motor 18 is changed. From FIG. 4, the larger the driving current I_{drive} is, the higher the rotate speed of the motor 18 for driving the rotate speed of the gear box 22 is, and the faster the disc-in and disc-out speeds are. Similarly, suppose that the adjusting unit 26 is a combination of a variable resistor and a constant current source. Current I provided by the constant current source and flowing through the variable resistor of the adjusting unit 26 is fixed. If the resistance of the variable resistor is changed, the driving voltage of the motor 18 is also changed. As can be seen from FIG. 5, at the same torque, the larger the driving voltage is, the faster the rotate speed of the motor 18 is, and the higher the rotate speed of gears of the gear box 22 and that of the roller 24 are, thereby accelerating the disc-in and disc-out speeds.

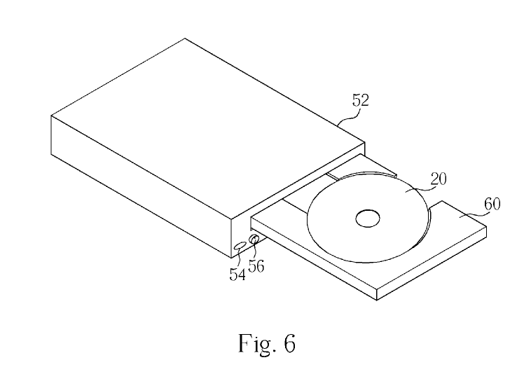

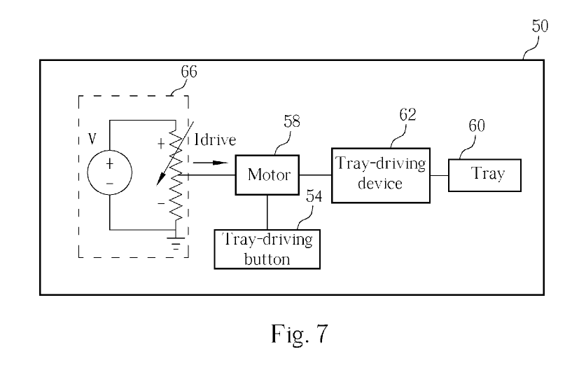

Please refer to FIG. 6 and FIG. 7. FIG. 6 shows a disc 20 on a tray 60 ejecting out of an optical disc drive 50 according to another embodiment of the present invention. FIG. 7 is a block diagram of the optical disc drive 50 shown in FIG. 6. The optical disc drive 50 comprises a housing 52, a tray-driving button 54, a speed-adjusting device 56, a motor 58, a tray 60, and a tray-driving device 62. The user can press the tray-driving button 54 or utilize a software interface by means of a computer to control the motor 58 to drive the tray-driving device 25 to feed or eject the tray 55. The speed-adjusting device 56, which can be a turntable or a knob, is used for adjusting a tray-in and tray-out speed. The tray 60 is used for supporting a disc 20.

The operation principle of the optical disc drive 50 is similar to the optical disc drive 10 of the previous embodiment, except that the motor 58 drives the tray-driving device 62 to eject or to feed the tray 60 instead of a disc 20.

The adjusting unit 26 or 66 can be software code stored in a memory. The user is able to control the adjusting unit 26 or 66 by means of an interface (for example, utilizing a keyboard or a mouse to control the software code displayed on a screen of a host) to adjust the rotate speed of the motor 18 or 58, so that the disc-in and disc-out speeds or the tray-in and tray-out speeds can be adjusted. The optical disc drive 10 or 50 can be a CD-R, DVD-R, DVD+R, DVD-RW, DVD+RW, DVD-RAM, or HD-DVD drive.

In contrast to the prior art, the present invention optical disc drive comprises an adjusting unit, by which the user can control the motors rotate speed to adjust the disc-in and disc-out speeds or the tray-in and tray-out speeds with respect to the housing. In this way, a clumsy user can utilize slower disc-in and disc-out speeds to prevent from injuring himself, and an impatient user can utilize faster disc-in and disc-out speeds to shorten the wait time. Consequently, it is more convenient for user to manipulate the present invention optical disc drive.

Those skilled in the art will readily observe that numerous modifications and alterations of the device may be made while retaining the teachings of the invention. Accordingly, that above disclosure should be construed as limited only by the metes and bounds of the appended claims.

1. An optical disc drive capable of adjusting disc-in and disc-out speeds comprising:
a housing;
an adjusting unit for adjusting a current or a voltage;
a motor for adjusting rotation speed based on the adjusted current or voltage; and
a roller driven by the motor for adjusting disc-in and disc-out speeds of a disc.

2. The optical disc drive of claim 1 wherein the adjusting unit is a variable voltage source or a variable current source.

3. The optical disc drive of claim 1 wherein the adjusting unit is software code stored in a memory.

4. The optical disc drive of claim 1 being a CD-R, DVD-R, DVD+R, DVD-RW, DVD+RW, DVD-RAM, or HD-DVD drive.

5. An optical disc drive capable of adjusting tray-in and tray-out speeds comprising:
a housing;
a tray for supporting a disc;
an adjusting unit for adjusting a current or a voltage;
a motor for adjusting rotation speed based on the adjusted current or voltage; and
a tray-driving device driven by the motor for adjusting tray-in and tray-out speeds based on the rotation speed of the motor.

6. The optical disc drive of claim 5 wherein the adjusting unit is a variable voltage source or a variable current source.

7. The optical disc drive of claim 5 wherein the adjusting unit is software code stored in a memory.

8. The optical disc drive of claim 5 being a CD-R, DVD-R, DVD+R, DVD-RW, DVD+RW, DVD-RAM, or HD-DVD drive.
